(19) United States
(12) Patent Application Publication
(10) Pub. No.: US 2011/0262602 A1
(43) Pub. Date: Oct. 27, 2011

(54) A PROCESS FOR OBTAINING RECONFIGURED RICE FROM RICE BY-PRODUCTS USED AS RAW MATERIALS, AND RECONFIGURED RICE RESULTING FROM SAID PROCESS

(76) Inventors: Rubén Osvaldo Bustos Cerda, Region Metropolitan (CL); Laura del Carmen Almendares Calderón, Region Metropolitan (CL)

(21) Appl. No.: 12/935,059

(22) PCT Filed: Apr. 7, 2009
(86) PCT No.: PCT/IB09/05207

§ 371 Date: Dec. 14, 2010

(30) Foreign Application Priority Data
Apr. 11, 2008 (CL) 1033-2008

(51) Int. Cl. A23L 1/10; A23P 1/12; A23L 1/308; A23L 1/30; A23L 1/275

(52) U.S. Cl. 426/250; 426/452; 426/618

(57) ABSTRACT

This invention is a process to modify the physical and chemical characteristics of powder or flour obtained from rice by-products from the rice peeling and polishing process, generating reconfigured grains, similar in appearance, shape, consistency, and uses, to normal peeled and polished rice grains. Also, the invention allows adding additives to give different flavors and colors, as well as nutritional additives and modifiers, during this reconfiguration process. The process uses rice by-products as raw materials, and the resulting product is reconfigured rice. To obtain this product, raw materials are ground, water is added and, eventually additives are added in order to produce a liquid mixture. The liquid mixture is placed in a double-screw extruder at 60° C. and 70° C. temperatures, and humidity between 34% and 40%; then, the mixture is put through a matrix to generate continuous, flexible, and humid filaments. The said filaments are cut into small segments and then dried to a humidity no higher than 15%, with the appearance, shape, and consistency of peeled and polished rice grains. The invention also includes reconfigured rice obtained from the procedure.

### APPLICATION FIELD OF THE INVENTION

This invention is a process to modify physical and chemical characteristics of powder or flour obtained from rice by-products and generate reconfigured grains, similar to normal rice grains in their appearance, shape, consistency, and uses, based on by-products obtained during the rice peeling and polishing process. The invention also allows adding additives to obtain different flavors and colors, as well as nutritional additives, during the reconfiguration process.

### PRIOR ART COMMENTS

The rice peeling-polishing process generates a range of by-products (skin, spent grains, bran, middling, flours, ends, half-grains, pieces, broken grains, among other) that correspond to nearly 25% of the grain original weight. Many of these by-products have a considerable intrinsic nutritional value, which is not possible to use for direct human consumption because nutrients are part of substrates with a less attractive look, and difficult to handle by the consumer. This situation makes the said by-products to be used as raw material for animal food and industrial processes. These uses significantly deteriorate price, compared to that of rice grains themselves, strongly affecting the production sector, mainly formed by small producers. Another aspect is related to rice grains' little versatility: it is a flat commodity with little variation in shape, flavor, color, and a nutritional level with no alternatives. Therefore, it is used “only as a garnish”.

In the prior art, there are several processes that form a dough that can be extruded to make rice of different qualities.

There is a variety of conventional methods used to produce rice dough. The process where rice, or rice and starch dough containing from 50 to 80% humidity is submitted to steam in order to gelatinize the starch and them cut it in the shape of noodles is well known. However, this process is messy, uses energy, and is expensive.

Document U.S. Pat. No. 4,435,435 (Hsu) discloses a process in which a mixture of raw rice flour, previously cooked rice flour, alginate gum, and water are extruded to shape them as dough.

Document EP 0450310 (Hsu et al.) discloses a procedure to prepare rice dough, which includes extrusion or lamination in the shape of a dough leaf of a dough mixture that includes raw rice flour and pre-cooked rice flour, with 40% maximum humidity contents, followed by pre-drying and cutting in the shape of pasta. The dough humidity contents is 30 to 40%, and the amount of pre-cooked rice flour present in the dough mixture is from 5 to 40% in weight, based on the raw rice flour weight. The dough mix contains one or more edible oils, egg white, or an alginate gum, where each one or more edible oils, egg white, and alginate gum component are present in the dough mix in amounts of 0.5 to 5% in weight, based on the weight of raw rice flour. In this process, a dough leaf is obtained and steamed before drying in order to obtain a partially pre-cooked rice dough leaf. The dough leaf is pre-dried in order to reach 20 to 35% humidity contents, and then it is cut in the shape of pasta in order to obtain rice pasta which is fresh and humid, with 15 to 30% humidity contents, and then dried again to get 3 to 12% humidity contents and dry pasta.

Document EP 0105100 (Lechthaler) describes a process to produce rice pasta through gelatinization, extrusion, and drying that includes mixing rice flour with soft water and an ionic gelatinizing agent such an alginate, in a cooking extruder in order to get dough with 35% to 55% water contents. The dough gelatinization is obtained by warming and kneading at 70 to 100 bar pressure, and at 60 to 100° C. temperature during 20 to 120 seconds. Then, the dough is cooled at less than 100° C., extruded in the shape of pasta. The pasta's contact with water containing one cation, such as divalent calcium, which forms a gel with the ionic gelatinizing agent, and the pasta drying are two stages after this process. In the process described in this document, the cation is used to solidify the ionic gelatinizing agent and form compact dough in a way similar to gluten, which gives the rice dough the cohesion it lacks.

Document ES 2164827 (Toh) discloses a process to produce instant rice noodles which includes: a) Steam-cooking the rice in order to gelatinize the starch and form pre-treated rice flour; b) Mixing pre-treated rice flour with hot water in order to get the dough; c) Extruding the dough to shape noodles; d) Steam-cooking the noodles; e) Bleaching steam-cooked noodles in hot water, and f) Drying the noodles to less than 15% humidity contents per weight. Rice used is long-grain rice with 21% to 28% amylose contents per weight. In this process, prior to steam-cooking, the rice is previously soaked in excess water and, after steam-cooking, the rice is ground and sifted to form pre-treated rice flour. Pre-treated rice flour is mixed with an insignificant amount of wheat starch before incorporating it to the dough. Also, an ionic gelatinizing agent is added, which may be dissolved in hot water before mixing pre-treated rice flour with hot water to form the dough. After extrusion, noodles are divided into portions to form a nest or compact mass. Noodles are steam-cooked during 5 to 75 minutes. Steam-cooked noodles are also bleached in order to totally or substantially complete starch gelatinization through bleaching in water at 80° C. until boiling point during 1 to 60 seconds. Noodles are dried at 50 to 70° C. temperature and 20% to 50% relative humidity during 30 minutes to 5 hours.

Document U.S. Pat. No. 4,276,321 (Yoshio Nagatami) discloses a method to prepare food in a pre-determined rice shape. The method includes the following stages: (a) Treating a pre-determined amount of boiled rice grains with a pre-determined amount of at least one ingredient in order to form a food mixture where boiled rice grains are in a mutual viscose condition with the ingredient, passing to a second, non-viscose condition, so that resistance to the said boiled rice grains' union in the treated mixture is weakened in order to prevent a pre-determined form of rice food once compressed; (b) Placing the said food pre-treated form into a container of pre-determined shape; (c) Freezing the said treated food mixture in the container; (d) Removing the said treated food mixture from the container; (e) Covering the said treated food mixture with in-hot contractible film; and (f) Warming the said contractible film, and then wrapping it in a freezing stage. Later, the wrapped mixture is soft and swollen. Wrapped rice grains are boiled and compressed.

The prior art shows that gelatinized pastas have the inconvenient of requiring large amounts of energy for cooking and drying. Conventional rice pasta may be dehydrated products containing 3% to 12% humidity, or they may be fresh humid products containing 40% to 80% humidity.

According to the literature checked, current use of rice by-products does not include re-configuring rice grains in order to make them look as superior rice grains, with the possibility of adding flavor, nutrition value, and color, obtaining a product that does not exist in the market.

There are other uses for grain by-products, which involve using extrusion technology, but their processes use different variables that cause serious starch modifications and expansion, which form very different food products not reconfiguring rice grains.

### ABSTRACT OF THE INVENTION

The purpose of this invention is valuing by-products of rice peeling and polishing process by modifying their physical and chemical characteristics, reconfigure rice grains, and complement components with additives that modify their flavor, color, nutritional value, and cooking characteristics through an extrusion process.

Several by-products from the peeling and polishing process have practically the same composition as normal rice grains, but they are ground as powder or flour, fragmented, or of reduced size, which makes them unfit to be marketed as rice, and are used as ingredients for pet food or raw material for other industrial processes such as fermentation and meat preserves, among other. All these uses mean a serious depreciation of rice by-products, which strongly affects crop profitability, as by-products are approximately 25% of the harvested grain. This is an especially serious problem for the majority of rice producers, small producers at the minimum living level. It is a well-known fact that they do not have the production alternative range offered by agriculture, as they own “rice soils” unfit for other type of crops.

The technical problem addressed is reconfiguring rice grains from by-products. For this purpose, the extrusion technique is used, which allows transforming this raw material in reconfigured rice grains with a similar appearance, shape, nutrition characteristics, organoleptic characteristics, and uses. In addition, it allows enriching rice grains as part of the same extrusion process through the incorporation of extra components such as flavoring, coloring, nutrients, and fiber, among other.

### DESCRIPTION OF THE INVENTION

This invention is a process to modify physical and chemical characteristics of powder or flour from rice peeling and polishing by-products and generate reconfigured grains, similar to normal rice grains in appearance, shape, consistency, and uses. In this process, rice by-products are used as raw materials, and the resulting product is reconfigured rice. In order to obtain this product, raw materials are ground and water is added and, eventually, additives are added such as beef, chicken, onion, garlic or other flavors. There is also a possibility to add fiber and form a liquid mixture. The liquid mixture is submitted, in a double-screw extruder, to temperatures between 60° C. and 70° C., and humidity between 34% and 40%; then, it is put through a matrix in order to generate continuous, flexible, and humid filaments. The said filaments are cut in small segments, and then placed under humidity no higher than 15%, taking an appearance, shape, and consistency similar to that of a peeled and polished rice grain.

This allows a process sequence as follows:

(a) Obtaining rice by-products volume;

(b) Grinding the said rice by-product volume to obtain a flour-type powder;

(c) Adding water to form a liquid mixture;

(d) Putting the liquid mixture through an extruder at a maximum temperature of 70° C. and maximum humidity of 40%;

(e) Putting the extruded mixture through a matrix to generate continuous, flexible, and humid filaments;

(f) Cutting the said filaments in small segments similar to grains in shape and size; and

(g) Drying the cut segments.

In the above-described process, it is possible that during stage (b) or (c), or during both, additives are added for different flavors and colors, as well as nutrition additives. The extruder used must be double-screw. Also, during stage (c), temperature may be between 60° C. and 70° C., and humidity may be between 34% and 40%. The product's maximum humidity may be 15%.

This invention's process uses rice by-products as raw material, and the resulting product is reconfigured rice whose appearance, shape, and consistency are similar to peeled and polished rice grains.

Through the above-described process, it is possible to obtain the following reconfigured rice types:

### Proximal Analysis

| | Humidity | | | Ashes | ENN(*) |
|---|---|---|---|---|---|
| Sample | (g/100 g) | Protein g/100 g | Fat g/100 g | g/100 g | g/100 g |
| Grade 1 rice pattern | 12.8 | 6.2 | 0.5 | 0.7 | 79.8 |
| Reconfigured rice without | 10.9 | 6.3 | 0.4 | 0.5 | 81.9 |
| flavoring | | | | | |
| Beef-flavor reconfigured rice | 9.9 | 6.6 | 0.1 | 1.1 | 82.3 |
| Chicken-flavor reconfigured rice | 10.6 | 6.8 | 0.2 | 1.1 | 81.3 |
| Garlic-flavor reconfigured rice | 11.4 | 6.4 | 0.1 | 0.8 | 81.3 |
| Onion-flavor reconfigured rice | 11.2 | 6.3 | 0.2 | 0.8 | 81.5 |
| Reconfigured rice with fiber | 12.4 | 6 | 0.1 | 0.7 | 80.8 |

In its different presentation, reconfigured rice does not show differences in its protein, fat, and carbohydrate contents compared to commercial rice.

| | Whiteness L | Value a + | Value b + |
|---|---|---|---|
| | (100 white | (red) − | (yellow) − |
| Sample | and 0 black) | (black) | (blue) |
| Grade 1 rice pattern | 72.5 | −0.03 | 16.6 |
| Grade 2 rice pattern | 73.1 | −0.54 | 16.4 |
| Reconfigured rice without | 65.0 | 2.7 | 19.3 |
| flavoring | | | |
| Beef-flavor reconfigured rice | 64.2 | 2.7 | 17.8 |
| Chicken-flavor reconfigured rice | 65.0 | 2.7 | 19.3 |
| Garlic-flavor reconfigured rice | 61.4 | 3.5 | 20.9 |
| Onion-flavor reconfigured rice | 61.7 | 3.5 | 21.3 |
| Reconfigured rice with fiber | 61.4 | 4.2 | 21.4 |

Reconfigured rice is slightly darker than commercial rice; however, this does not significantly affect its general appearance.

### Amylose Contents and Water Absorption Capacity

| | | Water absorption |
|---|---|---|
| | | capacity |
| Sample | Amylose % | (ml/100 g) |
| Grade 1 rice pattern | 11.4 | 240 |
| Reconfigured rice without flavoring | 18.5 | 385 |
| Beef-flavor reconfigured rice | 19.2 | 370 |
| Chicken-flavor reconfigured rice | 20.9 | 405 |
| Garlic-flavor reconfigured rice | 20.8 | 318 |
| Onion-flavor reconfigured rice | 21.5 | 308 |
| Reconfigured rice with fiber | 20.9 | 380 |

Amylose contents is a parameter related to rice behavior during cooking, and cooked rice texture. High values indicate rice with a large expansion volume and flakiness, soft cooked rice, with shape, and slightly hard.

Water absorption capacity is also related to rice's behavior during cooking.

For reconfigured rice, both parameters show higher values, which would explain cooking in a shorter time and with less water.

1. A process to obtain reconfigured rice from rice by-products used as raw materials, where the resulting product is the appearance, shape, and consistency of peeled and polished rice grains, WHEREIN it includes the following stages:
(a) Obtaining a rice by-products volume;
(b) Grinding the said rice by-products volume to obtain a flour-type powder;
(c) Adding water to form a liquid mixture;
(d) Putting the liquid mixture through an extruder at a maximum temperature of 70° C. and maximum humidity of 40%;
(e) Putting the extruded mixture through a matrix to generate continuous, flexible, and humid filaments;
(f) Cutting the said filaments into small segments similar in shape and size to rice grains; and
(g) Drying the cut segments.

2. A process to obtain reconfigured rice, according to claim 1, WHEREIN additives are added in phase (b) or (c), or in both, to add different flavors and colors, as well as nutritional additives and modifiers.

3. A process to obtain reconfigured rice, according to claim 1, WHEREIN in phase (d) the extruder is double-screw.

4. A process to obtain reconfigured rice, according to claim 1, WHEREIN in stage (d) temperature is between 60° C. and 70° C.

5. A process to obtain reconfigured rice, according to 1, WHEREIN in stage (d) humidity is between 34% and 40%.

6. A process to obtain reconfigured rice, according to 1, WHEREIN in stage (g) humidity of segments similar to rice grain in shape and size is not higher than 15%.

7. A process to obtain reconfigured rice, according to 2, WHEREIN additives used to give different flavors and colors are beef, chicken, garlic, onion, and other types.

8. A process to obtain reconfigured rice, according to claim 2, WHEREIN the additive is fiber.

9. Reconfigured rice from rice by-products used as raw materials, where the resulting product's appearance, shape, and consistency is similar to that of peeled and polished rice grains, WHEREIN humidity is between 10.6-12.8 g for every 100 g rice; protein is between 6.0-6.8 g for every 100 g rice; fat is between 0.1-0.5 g for every 100 g rice; ashes are between 0.5-1.1 g for every 100 g rice; and non-nitrogenous extract (ENN) is 80.8-82.3 g for every 100 g rice.

10. Reconfigured rice according to section 9, WHEREIN rice without flavoring has 10.9 g humidity for every 100 g rice; 6.3 g protein for every 100 g rice; 0.4 g fat for every 100 g rice; 0.5 g ashes for every 100 g rice; and 81.9 g ENN for every 100 g rice.

11. Reconfigured rice according to section 9, WHEREIN rice has beef flavor and 9.9 g humidity for every 100 g rice; 6.6 g protein for every 100 g rice; 0.1 g fat for every 100 g rice; 1.1 g ashes for every 100 g rice; and 82.3 g ENN for every 100 g rice.

12. Reconfigured rice according to section 9, WHEREIN rice has chicken flavor with 10.6 g humidity for every 100 g rice; 6.8 g protein for every 100 g rice; 0.2 g fat for every 100 g rice; 0.8 g ashes for every 100 g rice; and 81.5 g ENN for every 100 g rice.

13. Reconfigured rice according to section 9, WHEREIN rice has garlic flavor and 11.4 g humidity for every 100 g rice; 6.4 g protein for every 100 g rice; 0.1 g fat for every 100 g rice; 0.8 g ashes for every 100 g rice; and 81.3 g ENN for every 100 g rice.

14. Reconfigured rice according to section 9, WHEREIN has onion flavor and 11.2 g humidity for every 100 g rice; 6.3 g protein for every 100 g rice; 0.2 g fat for every 100 g rice; 0.8 g ashes for every 100 g rice; and 81.5 g ENN for every 100 g rice.

15. Reconfigured rice according to section 9, WHEREIN rice with fiber has 12.4 g humidity for every 100 g rice; 6.0 g protein for every 100 g rice; 0.1 g fat for every 100 g rice; 0.7 g ashes for every 100 g rice; and 80.8 g ENN for every 100 g rice.

16. Reconfigured rice according claim 9, WHEREIN amylase percentage is between 11.4 and 21.5, and water absorption capacity is between 240 and 405 ml for every 100 g rice.

17. Reconfigured rice according to section 16, WHEREIN rice without flavoring has 18.5 amylase percentage, and water absorption capacity is ml for every 100 g rice.

18. Reconfigured rice according to section 16, WHEREIN rice with beef flavor has 19.2 amylose percentage, and its water absorption capacity is 370 ml for every 100 g rice.

19. Reconfigured rice according to section 16, WHEREIN rice with chicken flavor has 20.9 amylose percentage, and its water absorption capacity is 405 ml for every 100 g rice.

20. Reconfigured rice according to section 16, WHEREIN rice with garlic flavor has 20.8 amylose percentage, and its water absorption capacity is 318 ml for every 100 g rice.

21. (canceled)

22. (canceled)
